(19) United States
(12) Patent Application Publication
(10) Pub. No.: US 2005/0258938 A1
(43) Pub. Date: Nov. 24, 2005

(54) Portable electronic devices including customization circuits for customizing alert signals and methods of operating the same

(76) Inventor: John L. Moulson, Raleigh, NC (US)

Correspondence Address: Elizabeth A. Stanek;Myers Bigel Sibley & Sajovec, Post Office Box 37428, Raleigh, NC, 27627, US

(21) Appl. No.: 10/850,685

(22) Filed: May 21, 2004

(51) Int. Cl. H04Q 1/30

(52) U.S. Cl. 340/7.58; 340/691.1; 455/67.7

(57) ABSTRACT

Portable electronic devices are provided including a customization circuit and a transmitter. The customization circuit is configured to customize an alert signal associated with an originating portable electronic device. The transmitter is configured to transmit the customized alert signal from the originating portable electronic device and transmit a request for communication from the originating portable electronic device to a receiving portable electronic device so as to allow a user of the receiving portable electronic device to be alerted using the customized alert signal. Related methods of operating portable electronic devices including customization circuits are also discussed.

### FIELD OF THE INVENTION

The present invention relates to portable electronic devices and, more particularly, to portable electronic devices having customized ringtones and methods of operating the same.

### BACKGROUND OF THE INVENTION

Recently, there has been a proliferation in the field of wireless communications. Portable electronic devices such as cordless and cellular telephones, pagers, wireless modems, wireless email devices, personal digital assistants (PDAs) with communication functions, and other portable electronic devices are becoming commonplace. These portable electronic devices typically have an alert signal to notify the user when an incoming communication, such as a call or a page, arrives. Because of the proliferation of portable electronic devices, more than one portable electronic device may be present in a particular environment, for example, a restaurant, simultaneously. Accordingly, it may be difficult to distinguish an alert signal of one portable electronic device from another in these environments.

Conventional portable electronic devices allow a user to customize a ringtone used to notify the user of an incoming communication and/or to associate a unique ringtone, image or the like with a particular contact in a contact list. Conventional portable electronic devices may provide a minimal amount of differentiation among alert signals of multiple portable electronic devices. However, improved portable electronic devices and related methods may be desired.

### SUMMARY OF THE INVENTION

Some embodiments of the present invention provide portable electronic devices including a customization circuit and a transmitter. The customization circuit is configured to customize an alert signal associated with an originating portable electronic device. The transmitter is configured to transmit the customized alert signal and transmit a request for communication between the originating portable electronic device and a receiving portable electronic device so as to allow a user of the receiving portable electronic device to be alerted using the customized alert signal.

In further embodiments of the present invention, the customized alert signal associated with the originating portable electronic device may be stored at the receiving portable electronic device. The customized alert signal may be stored with a contact list entry associated with a user of the portable electronic device. The customized alert signal may include a text message, an image, a mechanical vibration, a video clip and/or an audio clip.

In still further embodiments of the present invention, the transmitter may be further configured to transmit the customized alert signal to a plurality of receiving portable electronic devices. The plurality of receiving portable electronic devices may be selected from a contact list of the receiving portable electronic devices associated with the originating portable electronic device. The transmitter may be further configured to transmit a short message service (SMS) message, an enhanced messaging system (EMS) message and/or a multimedia messaging service (MMS) message including the customized alert signal.

Some embodiments of the present invention include a receiver and a memory. The receiver is configured to receive a customized alert signal associated with an originating portable electronic device from the originating portable electronic device. The memory is configured to store the customized alert signal associated with the originating portable electronic device.

In further embodiments of the present invention, a receiving portable electronic device further includes a processor configured to obtain permission from a user of the receiving portable electronic device to store the customized alert signal in the memory. The memory may be further configured to store the customized alert signal if permission is obtained.

In still further embodiments of the present invention, the memory may be further configured to store the customized alert signal with a contact list entry associated with the originating portable electronic device. The receiver may be further configured to receive a request for a communication from the originating portable electronic device. The receiving portable electronic device may further include a processor configured to alert a user of the portable electronic device of the communication using the customized alert signal associated with the originating portable electronic device.

While the present invention is described above primarily with reference to portable electronic devices, methods of operating portable electronic devices are also provided.

### BRIEF DESCRIPTION OF THE DRAWINGS

FIG. 1A is a schematic diagram of mobile terminals according to some embodiments of the present invention and an exemplary base station transceiver.

FIG. 1B is a schematic diagram of originating mobile terminals according to some embodiments of the present invention and an exemplary base station transceiver.

FIG. 1C is a schematic diagram of receiving mobile terminals according to some embodiments of the present invention and an exemplary base station transceiver.

FIG. 2 is a diagram of an exemplary message including fields of a customized alert signal according to some embodiments of the present invention.

FIG. 3 is diagram of an exemplary contact list including customized alert signals according to some embodiments of the present invention.

FIG. 4 is a flowchart illustrating operations of portable electronic devices according to some embodiments of the present invention

FIG. 5 is a flowchart illustrating operations of portable electronic devices according to further embodiments of the present invention.

FIG. 6 is a flowchart illustrating operations of portable electronic devices according to still further embodiments of the present invention

FIG. 7 is a flowchart illustrating operations of portable electronic devices according to some embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items. As will be appreciated by one of skill in the art, the present invention may take the form of an entirely hardware embodiment, an entirely software embodiment or an embodiment combining software and hardware aspects all generally referred to herein as a “circuit” or “module.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

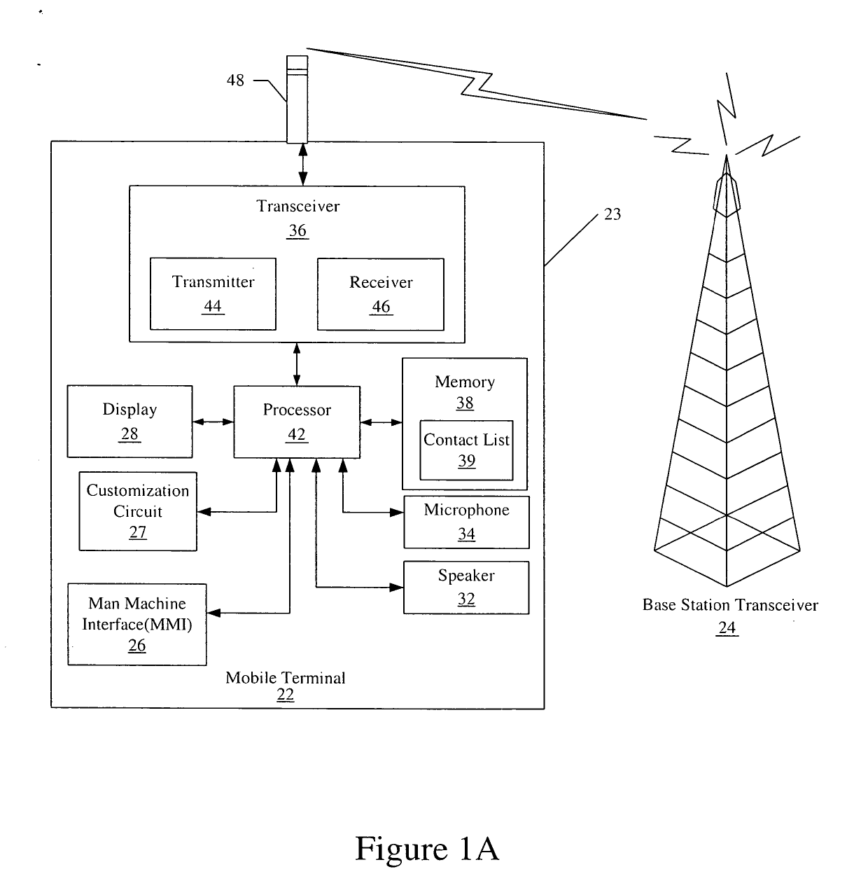

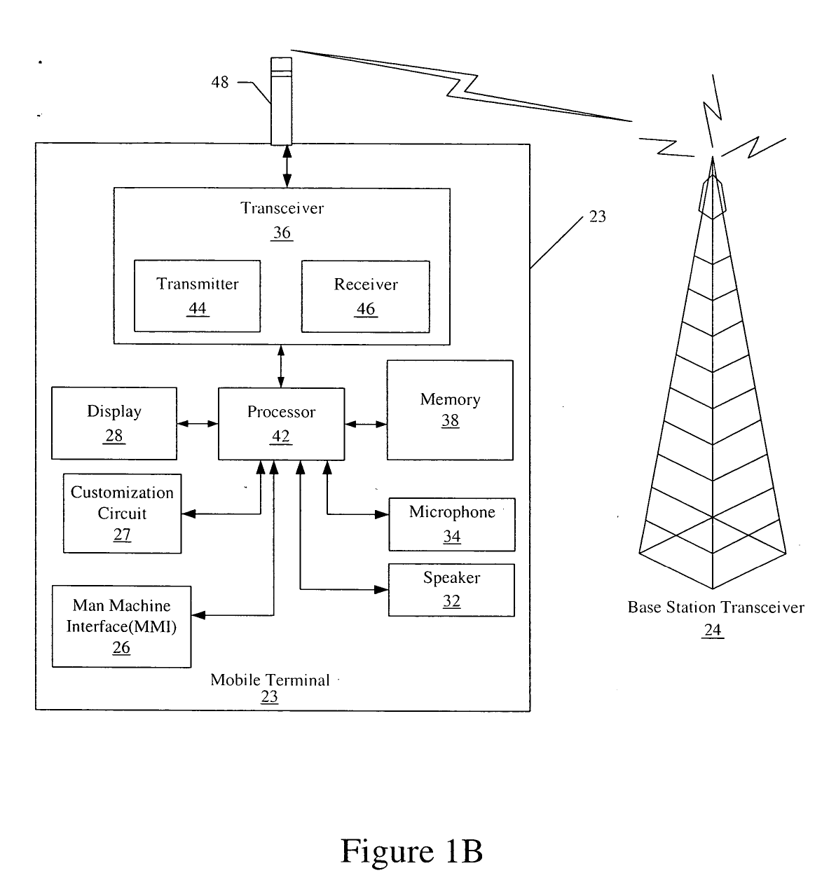

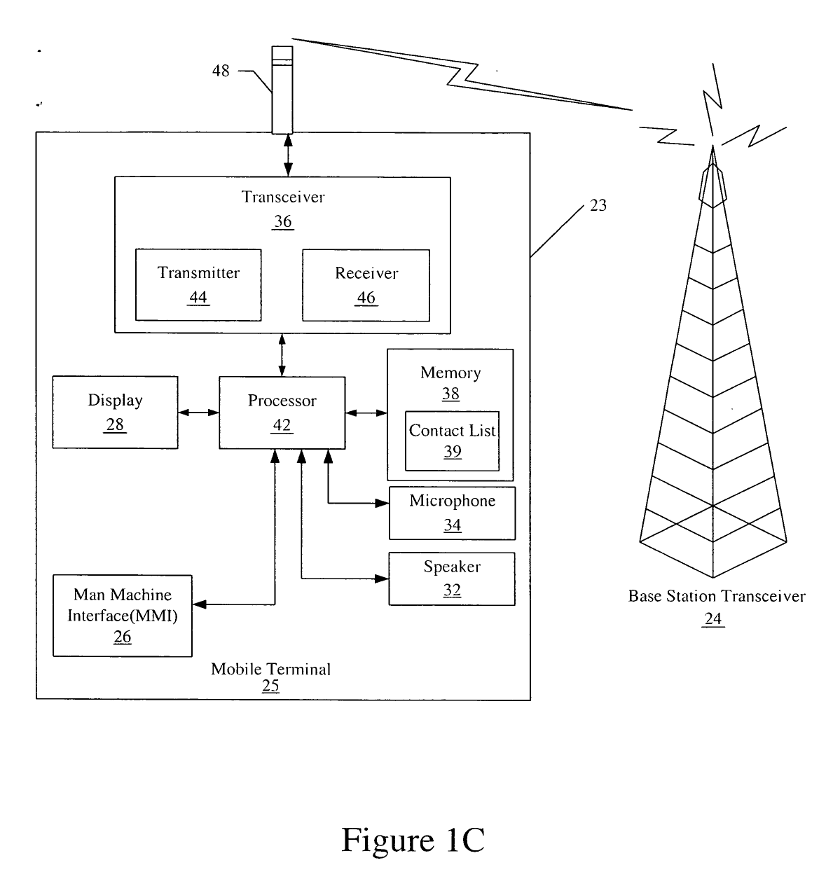

Embodiments of the present invention will now be described below with respect to FIGS. 1A through 7. Embodiments of the present invention provide portable electronic devices including customization circuits. The customization circuit may be configured to customize an alert signal associated with a portable electronic device originating a communication. The customized alert signal may be transmitted to one or more portable electronic devices configured to receive the communication. The user of the receiving portable electronic device may choose to store the customized alert signal. Accordingly, a user of the receiving portable electronic device may be alerted using the stored customized alert signal associated with the originating portable electronic device when a communication is received. Thus, improved alerting signals and features may be provided according to embodiments of the present invention as discussed herein below.

The present invention is described below with reference to schematic and block diagrams of mobile terminals including customization circuits according to some embodiments of the present invention. Although customization circuits are discussed herein as being included as part of a mobile terminal, for example, mobile terminals 22, 23 and 25 of FIGS. 1A through 1C, embodiments of the present invention are not limited to this configuration. Customization circuits according to embodiments of the present invention may be included in any portable electronic device that utilizes an alerting signal without departing from the scope of the present invention.

Referring now to FIG. 1A, illustrating an exemplary radiotelephone communication system in accordance with embodiments of the present invention, which includes the mobile terminal 22 and a base station transceiver 24 of a wireless communications network. The mobile terminal 22 includes a portable housing 23 and may include a man machine interface 26, a display 28, a speaker 32, a microphone 34, a transceiver 36, and a memory 38 including a contact list 39, any of which may communicate with a processor 42. Furthermore, mobile terminals 22 according to embodiments of the present invention may further include a customization circuit 27 according to embodiments of the present invention, which also communicates with a controller/processor 42. The processor 42 can be any commercially available or custom microprocessor.

The transceiver 36 typically includes a transmitter circuit 44 and a receiver circuit 46, which respectively transmit outgoing radio frequency signals to the base station transceiver 24 and receive incoming radio frequency signals, such as voice signals, from the base station transceiver 24 via an antenna 48. The antenna 48 may be an embedded antenna, a retractable antenna or any antenna known to those having skill in the art without departing from the scope of the present invention. The radio frequency signals transmitted between the mobile terminal 22 and the base station transceiver 24 may include both traffic and control signals (e.g., paging signals/messages for incoming calls), which are used to establish and maintain communication with another party or destination. The processor 42 may Support various functions of the mobile terminal 22, including customization of alert signals associated with an originating mobile terminal.

As used herein, the term “portable electronic device” or “mobile terminal” may include: a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; a gaming device, an audio video player, and a conventional laptop and/or palmtop portable computer that may include a radiotelephone transceiver.

In some embodiments of the present invention, the base station transceiver 24 comprises the radio transceiver(s) that defines an individual cell in a cellular network and communicates with the mobile terminal 22 and other mobile terminals in the cell using a radio-link protocol. Although only a single base station transceiver 24 is shown, it will be understood that many base station transceivers may be connected through, for example, a mobile switching center and other devices to define a wireless communications network.

Although the present invention may be embodied in communication devices or systems, such as the mobile terminal 22, the present invention is not limited to Such devices and/or systems. Instead, the present invention may be embodied in any apparatus that may utilize a customization circuit according to embodiments of the present invention.

As illustrated in FIG. 1A, the customization circuit 27 may be configured to customize an alert signal associated with an originating mobile terminal. An exemplary originating mobile terminal 23 is illustrated in FIG. 1B. As used herein, the “originating portable electronic device” or “originating mobile terminal” refers to a portable electronic device originating a communication between the originating portable electronic device and one or more receiving portable electronic devices. An exemplary receiving mobile terminal 25 is illustrated in FIG. 1C. As further used herein, the “receiving portable electronic device(s)” or “receiving mobile terminal(s)” refers to a portable electronic device receiving a communication from the originating portable electronic device. It will be understood that portable electronic devices may be configured to transmit customized alert signals, such as originating mobile terminal 23 of FIG. 1B, receive customized alert signals, such as receiving mobile terminal 25 of FIG. 1C, or both transmit and receive customized alert signals such as mobile terminal 22 of FIG. 1A without departing from the teachings of the present invention.

Referring again to FIGS. 1A through 1C, the transmitter 44 may be configured to transmit the customized alert signal from the originating mobile terminal 23 to one or more receiving mobile terminals 25. The customized alert signal may include a text message, an image, a mechanical vibration, a video clip, an audio clip and the like. In certain embodiments of the present invention, the customized alert signal may include a customized icon and/or audio clip for, for example, a push to talk buddy list. The customized alert signal may be included in,

For example, a multimedia messaging service (MMS) message. The Multimedia Messaging Service (MMS) has the ability to send messages including a combination of text, sounds, images and video to mobile terminals. MMS messages may be sent to a mobile terminal configured to receive MMS messages or may be sent via web sites, i.e., the user of the mobile terminal may receive a short message service (SMS) message pointing to a Universal Resource Locator (URL) where the MMS message is stored.

In particular, MMS may be implemented using a combination of wireless access protocol (WAP) and SMS technologies. As discussed above, MMS enables the transmission of multimedia messages containing content such as pictures, graphics, music, images, ringtones and the like. The MMS standard includes an MMS mail client on the device such as a portable electronic device, a WAP gateway for sending and receiving messages and a multimedia messaging service center (MMSC) for storing, transcoding and relaying messages.

An MMS message may be created by an application or by a user sending the message from an originating mobile terminal 23. It will be understood that the originating mobile terminal 23 may be WAP enabled. The MMS message may be sent from an originating mobile terminal 23 and connected to an MMSC via, for example, WAP. The MMS message may then be transmitted to the MMSC. The MMSC may take over responsibility for delivery of the MMS message.

The MMS message may be published by, for example, the MMSC, so that it is accessible via, for example, a URL. An MMS notification message may be sent to the receiving mobile terminal 25, encapsulated in a WAP push message, which itself may be encoded as, for example, a binary SMS message. This MMS notification message may contain header information about the MMS message, and a URL pointer that may contain instructions on how the receiving mobile terminal 25 can retrieve the content of the MMS message. The receiving mobile terminal 25 may, for example, open a WAP session and retrieve the MMS message content from the URL included in the MMS notification message. Further details with respect to MMS messaging are known to those having skill in the art and will not be discussed further herein.

Although the customized alert signal is discussed herein as being included in an MMS message, embodiments of the present invention are not limited to this configuration. For example, customized alert signals may be included in short message service (SMS) message, an enhanced messaging system (EMS) message and the like without departing from the scope of the present invention. However, it will be understood that SMS messages and EMS messages may have limitations on the type of content that may be sent in the message.

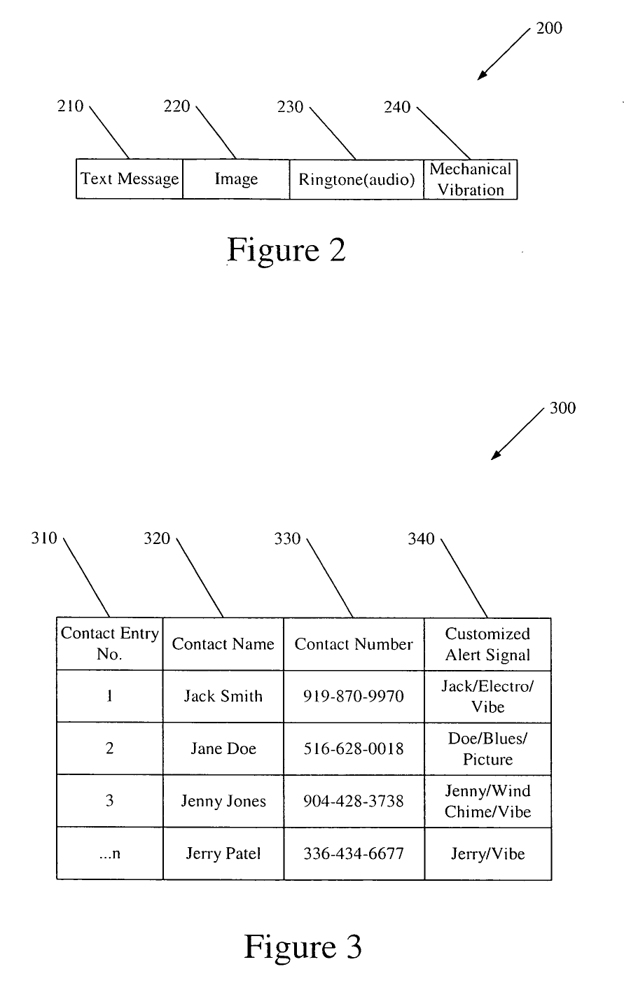

Referring now to FIG. 2, an exemplary message 200 including fields of a customized alert signal according to embodiments of the present invention will be discussed. As illustrated, the customized alert signal may include one or more fields, a text message field 210, an image field 220, a ringtone field 230, and a mechanical vibration field 240. For example, the text message field 210 may include the name of a user of the originating mobile terminal 23, for example, “Jack Smith.” Similarly, the image field 220, may include a picture of the user of the originating mobile terminal 23 or an image associated with the user. The ringtone field 230 may include any of a number of commercially available ringtones. The mechanical vibration field 240 may include an indication of whether or not the receiving mobile terminal 25 should vibrate when a communication is received from the originating mobile terminal 23. The mechanical vibration may also be any of a number of commercially available vibration signals. It will be understood that the message 200 is provided for exemplary purposes and embodiments of the present invention are not limited to this configuration.

Referring again to FIGS. 1A through 1C, the transmitted customized alert signal may be received at one or more receivers 46 of receiving mobile terminals 25. The received customized alert signal may be stored at the receiving mobile terminal 25. In certain embodiments of the present invention, the processor 42 may be configured to obtain permission from the user of the receiving mobile terminal 25 to store the customized alert signal associated with the originating mobile terminal 23. For example, the received customized alert signal may be stored in, for example, the memory 38 of the receiving mobile terminal 25. In some embodiments of the present invention, the received customized alert signal may be stored in a contact list 39 in the memory 38, for example, with a contact list entry associated with a user of the originating mobile terminal 23.

Referring now to FIG. 3, an exemplary contact list 300 including customized alert signals according to embodiments of the present invention will be discussed. As illustrated, the contact list 300 includes multiple fields, a contact entry number field 310, the contact name field 320, the contact number field 330 and the customized alert signal field 340. In particular, as illustrated in FIG. 3, contact entry number 1 is for Jack Smith at 919-870-9970 and Jack's customized alert signal includes his name “Jack”, a ringtone entitled “Electro” and a mechanical vibration (vibe). Furthermore, contact entry number 2 is for Jane Doe at 516-628-0018 and Jane's customized alert signal includes her last name “Doe”, a ringtone entitled “Blues” and a picture, such as a picture of Jane. Similarly, for contact entry numbers 3 through n. The contact list 300 of FIG. 3 is provided for exemplary purposes only and, therefore, embodiments of the present invention should not be limited to this configuration.

Referring again to FIGS. 1A through 1C, the transmitter 44 of the originating mobile terminal 23 may transmit a request for communication with the receiving mobile terminal 25. The receiver 46 of the receiving mobile terminal 25 may receive the request and the customized alert signal may be activated at the receiving mobile terminal 25. It will be further understood that although the customization circuit 27 is illustrated as separate from the processor 42 in FIGS. 1A and 1B, embodiments of the present invention are not limited to this configuration. For example, the customization circuit 27 may be at least partially included in the processor 42 without departing from the scope of the present invention.

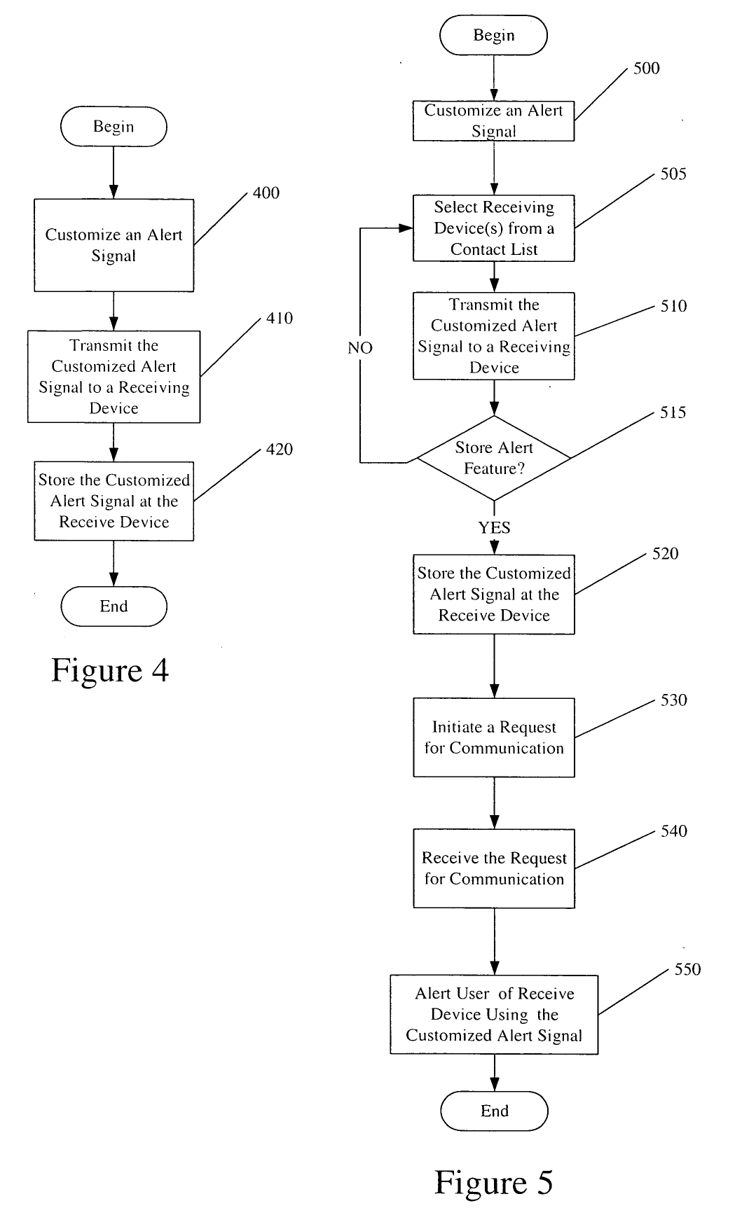

Referring now to FIGS. 4 through 7, operations of portable electronic devices including customization circuits according to some embodiments of the present invention will be discussed. Referring now to FIG. 4, operations begin at block 400 by customizing an alert signal associated with an originating portable electronic device. As discussed above, the customized alert signal may include a text message, an image, a mechanical vibration, a video clip, an audio clip and the like. The customized alert signal may be transmitted from an originating portable electronic device to a receiving portable electronic device (block 410). The customized alert signal may be transmitted in an MMS, SMS and/or EMS message without departing from the scope of the present invention. The customized alert signal associated with the originating portable electronic device may be stored at the receiving portable electronic device (block 420).

Referring now to FIG. 5, operations begin at block 500 by customizing an alert signal associated with an originating portable electronic device. One or more receiving portable electronic devices may be selected from a plurality of contact list entries at the originating portable electronic device (block 505). The customized alert signal may be transmitted to the selected receiving portable electronic devices from the originating portable electronic device (block 510). It is determined if the user(s) of the receiving portable electronic device(s) has granted permission for the customized alert signal to be stored (block 515). If the user of the receiving portable electronic device(s) does not grant permission to store the customized alert signal, the process is terminated with respect to the particular receiving portable electronic device and operations return to block 505 and repeat.

If, on the other hand, the user has granted permission, the customized alert signal associated with the originating portable electronic device may be stored at the receiving portable electronic device (block 520). In some embodiments of the present invention, the customized alert signal may be stored with a contact list entry associated with the user of the originating portable electronic device. A request for a communication is initiated between the originating portable electronic device and the receiving portable electronic device (block 530). The request is received at the receiving portable electronic device (block 540) and the user of the receiving portable electronic device is alerted using the customized alert signal (block 550).

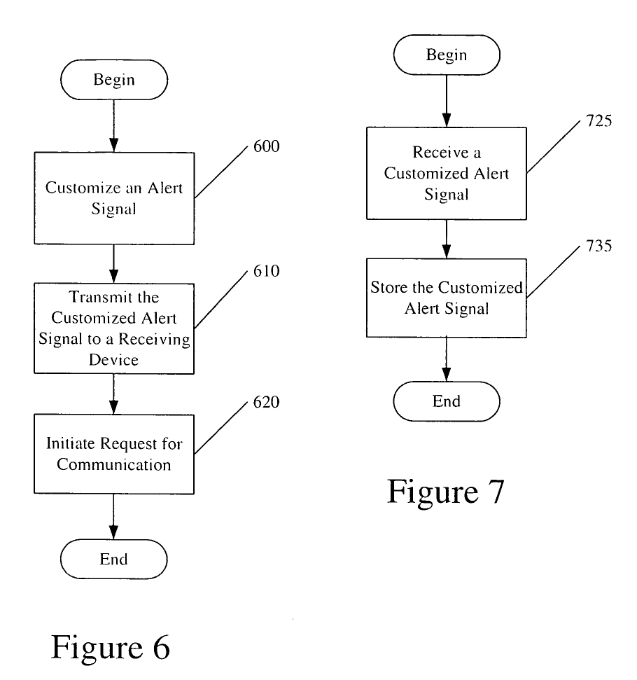

Referring now to FIG. 6, operations begin at block 600 by customizing an alert signal associated with an originating portable electronic device. The customized alert signal may be transmitted to one or more receiving portable electronic devices (block 610). A request may be initiated for a communication between the originating portable electronic device and a receiving portable electronic device so as to allow a user of the receiving portable electronic device to be alerted using the customized alert signal (block 620).

Referring now to FIG. 7, operations begin at block 725 by receiving a customized alert signal associated with an originating portable electronic device from the originating portable electronic device at a receiving portable electronic device. The customized alert signal associated with the originating portable electronic device may be stored at the receiving portable electronic device (735).

As briefly discussed above with respect to FIGS. 1 through 7, embodiments of the present invention provide portable electronic devices having customization circuits. The customization circuit may be configured to customize an alert signal for an originating portable electronic device. A transmitter may be configured to transmit the customized alert signal to one or more receiving portable electronic devices which may or may not choose to store the customized alert signal. Thus, when a communication is initiated between the originating portable electronic device and a receiving portable electronic device that has stored the customized alert signal, the receiving portable electronic device may be alerted using the customized alert signal. Accordingly, portable electronic devices including customization circuits according to embodiments of the present invention may allow for further personalization of the portable electronic device experience by enabling the call originator to express their personality through the customized alert signal. Furthermore, portable electronic devices according to embodiments of the present invention may facilitate further sharing of ringtones and images and may allow further differentiation of alert signals in a public area.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of operating portable electronic devices, comprising:
customizing an alert signal associated with an originating portable electronic device;
transmitting the customized alert signal to at least one receiving portable electronic device; and
storing the customized alert signal associated with the originating portable electronic device at the at least one receiving portable electronic device.

2. The method of claim 1, further comprising:
initiating a request for the communication at the originating portable electronic device;
receiving the request at the receiving portable electronic device; and
alerting a user of the receiving portable electronic device of the communication using the customized alert signal.

3. The method of claim 1, wherein storing is preceded by obtaining permission from a user of the receiving portable electronic device to store the customized alert signal associated with the originating portable electronic device and wherein storing further comprises storing the customized alert signal if permission is obtained.

4. The method of claim 3, wherein storing further comprises storing the customized alert signal with a contact list entry associated with the originating portable electronic device.

5. The method of claim 1, wherein the customized alert signal comprises at least one of a text message, an image, a mechanical vibration, a video clip and an audio clip.

6. The method of claim 1, wherein transmitting further comprises transmitting the customized alert signal to a plurality of receiving portable electronic devices.

7. The method of claim 6 wherein customizing is followed by selecting the plurality of receiving portable electronic devices from a contact list of receiving portable electronic devices associated with the originating portable electronic device.

8. The method of claim 1 wherein transmitting the customized alert signal comprises transmitting at least one of a short message service (SMS) message, an enhanced messaging system (EMS) message and a multimedia messaging service (MMS) message including the customized alert signal.

9. A method of operating a portable electronic device, comprising:
customizing an alert signal associated with an originating portable electronic device;
transmitting the customized alert signal to a receiving portable electronic device; and
initiating a request for communication between the originating portable electronic device and the receiving portable electronic device so as to allow a user of the receiving portable electronic device to be alerted using the customized alert signal.

10. The method of claim 9, wherein the customized alert signal comprises at least one of a text message, an image, a mechanical vibration, a video clip and an audio clip.

11. The method of claim 9, wherein transmitting further comprises transmitting the customized alert signal to a plurality of receiving portable electronic devices.

12. The method of claim 11 wherein customizing is followed by selecting the plurality of receiving portable electronic devices from a contact list of receiving portable electronic devices associated with the originating portable electronic device.

13. The method of claim 9 wherein transmitting the customized alert signal comprises transmitting at least one of a short message service (SMS) message, an enhanced messaging system (EMS) message and a multimedia messaging service (MMS) message including the customized alert signal.

14. A method of operating a portable electronic device, comprising:
receiving a customized alert signal associated with an originating portable electronic device from the originating portable electronic device at a receiving portable electronic device; and
storing the customized alert signal associated with the originating portable electronic device at the receiving portable electronic device.

15. The method of claim 14, wherein storing is preceded by obtaining permission from a user of the receiving portable electronic device to store the customized alert signal associated with the originating portable electronic device and wherein storing further comprises storing the customized alert signal if permission is obtained.

16. The method of claim 15, wherein storing further comprises storing the customized alert signal with a contact list entry associated with the receiving portable electronic device.

17. The method of claim 14 further comprising:
receiving a request for a communication from the originating portable electronic device at the receiving portable electronic device; and
alerting a user of the receiving portable electronic device of the communication using the customized alert signal.

18. A portable electronic device comprising:
a customization circuit configured to customize an alert signal associated with an originating portable electronic device; and
a transmitter configured to transmit the customized alert signal to a receiving portable electronic device and transmit a request for communication from the originating portable electronic device to the receiving portable electronic device so as to allow a user of the receiving portable electronic device to be alerted using the customized alert signal.

19. The portable electronic device of claim 18 wherein the customized alert signal is stored with a contact list entry associated with the originating portable electronic device.

20. The portable electronic device of claim 18, wherein the customized alert signal comprises at least one of a text message an image, a mechanical vibration, a video clip and an audio clip.

21. The portable electronic device of Claim 18 wherein the transmitter is further configured to transmit the customized alert signal to a plurality of receiving portable electronic devices.

22. The portable electronic device of claim 21 wherein the plurality of receiving portable electronic devices are selected from a contact list of receiving portable electronic devices associated with the originating portable electronic device.

23. The portable electronic device of claim 18 wherein the transmitter is further configured to transmit at least one of a short message service (SMS) message, an enhanced messaging system (EMS) message and a multimedia messaging service (MMS) message including the customized alert signal.

24. A portable electronic device comprising:
a receiver configured to receive a customized alert signal associated with an originating portable electronic device from the originating portable electronic device; and
a memory configured to store the customized alert signal associated with the originating portable electronic device.

25. The portable electronic device of claim 24, further comprising a processor configured to obtaining permission from a user of a receiving portable electronic device to store the customized alert signal associated with the originating portable electronic device in the memory and wherein the memory is further configured to store the customized alert signal if permission is obtained.

26. The portable electronic device of claim 25 wherein the memory is further configured to store the customized alert signal with a contact list entry associated with the originating portable electronic device.

27. The portable electronic device of claim 24 wherein the receiver is further configured to receive a request for a communication from the originating portable electronic device, the receiving portable electronic device further comprising a processor configured to alert a user of the receiving portable electronic device of the communication using the customized alert signal associated with the originating portable electronic device.

28. The portable electronic device of claim 24, wherein the customized alert signal comprises at least one of a text message, an image, a mechanical vibration, a video clip and an audio clip.
